(19) United States
(12) Patent Application Publication
(10) Pub. No.: US 2010/0163473 A1
(43) Pub. Date: Jul. 1, 2010

(54) APPARATUS FOR WASTEWATER TREATMENT AND A PLANT EQUIPPED WITH SUCH AN APPARATUS

(75) Inventor: Johan Verink, Woelpinghausen (DE)

Correspondence Address: Leason Ellis LLP, 81 Main Street, Suite 503, White Plains, NY, 10601, US

(73) Assignee: Johan Verink, Woelpinghausen (DE)

(21) Appl. No.: 12/303,935

(22) PCT Filed: May 29, 2007
(86) PCT No.: PCT/DE07/00961

§ 371 Date: Dec. 8, 2008

(30) Foreign Application Priority Data
Jun. 6, 2006 (DE) 10 2006 027 031.2

(51) Int. Cl. B01D 21/24; C02F 1/20; C02F 1/00

(52) U.S. Cl. 210/188; 210/519

(57) ABSTRACT

An apparatus for treating wastewater includes a treatment tank having a first edge region and a second edge region opposite the first edge region, a feed line configured to provide the wastewater to the treatment tank, a movable wastewater distributor connected to an end of the feed line and configured to distribute the wastewater in the treatment tank, and a traction mechanism. The wastewater distributor includes a plurality of outlet openings and is moveable within the treatment tank and the traction mechanism is configured to move the wastewater distributor in a reversing manner between the first and second opposite edge regions of the treatment tank. The feed line is elastically deformable so as to allow a movement of the wastewater distributor in a direction of back and forth movement.

This application is a U.S. National Phase application under 35 U.S.C. §371 of International Application No. PCT/DE2007/000961, filed on May 29, 2007, which claims priority to German Patent Application No. DE 10 2006 027 031.2, filed on Jun. 8, 2006. The International Application was published in German on Dec. 13, 2007 as WO 2007/140744 under PCT Article 21(2).

The present invention relates to an apparatus for the treatment of wastewater, with at least one feed line and with a movable wastewater distributor for the wastewater which is to be treated, which wastewater distributor is provided with outlet openings and can be positioned in a treatment tank. Furthermore, the present invention relates to a plant equipped with such an apparatus.

### BACKGROUND

An apparatus of this type is described, for example, in DE 33 24 072 C2 concerning the anaerobic purification of wastewater. For this purpose, the apparatus has a digestion tank in which a tubular feed line with a wastewater distributor designed as a distributor arm is mounted rotatably about a perpendicular axis. Pipes are connected fixedly to the feed line and the wastewater distributor, the length of which pipes is stepped in such a manner that the wastewater introduced is distributed as uniformly as possible over a bottom of the tank. Sludge scrapers are arranged on two distributor arms of the wastewater distributor, said sludge scrapers transporting suspended matter deposited on the bottom of the tank to an outlet.

Furthermore, EP 00 00 293 B1 also describes a method for the treatment of waste material, in which the deposition and compaction of the sludge on the bottom of the tank is prevented by means of at least one gas distributor arm which rotates about a central axis of the tank and from which a gas is discharged at a multiplicity of outlet openings along the extent of the gas distributor arm.

A disadvantage of the above apparatuses is that the cleaning or repair of the structural elements submerged in the tank require the tank to be emptied first. This is associated with a considerable outlay and in particular also with an undesirable shutdown of the plant.

DE 10 2004 021 022 B3 describes an apparatus for the anaerobic cleaning of wastewater, with a tank and with a wastewater admission arrangement for purified waste-water. The wastewater admission arrangement has at least two distributor planes, in each of which pipelines having discharge openings are arranged immovably.

A disadvantage of said immovable arrangement of the distributor is the large number of pipelines required for the uniform distribution in the tank. In practice, there is currently at least one outlet opening per square meter of tank area. In addition, considerable pipe diameters arise because of the pressure required, thus resulting in an overall large outlay on production.

A wastewater treatment plant according to DE 39 27 881 A1 for purifying wastewater comprises a housing in which a conveyor with scrapers runs on rollers and is reversibly driven by a shaft. The conveyor is arranged on the bottom and in the liquid surface of an input chamber. A chamber is formed in the bottom for the collection of sludge, with a perforated pipe which is connected to a sludge pump being located therein.

DE 43 37 469 C1 describes a plant for the treatment of wastewater and sludge, which is equipped with a reactor and, for the collection of gas, with a pipe system arranged in the water phase of the reactor. The pipe system is arranged on at least one support floating in the reactor, and the wastewater can be fed in or sludge can be removed via said pipe system.

In addition, DD 235 247 discloses in general the biological purification of wastewater containing organic impurities, with the aid of anaerobic microorganisms. The biomass available for the degradation of the organic impurities is increased, taking the concentration dependency of the reaction speed of biological processes into consideration, in such a manner that the same degradation capacity is always achieved throughout the entire digestion space through which the flow passes. For this purpose, additional growth surfaces for the biomass are built into the digestion chamber alternately at two different heights.

Furthermore, DE 20 2004 000 669 U1 also describes an apparatus for the treatment of wastewater, with a line for removing the liquid. The apparatus has a movable liquid pump which serves as the liquid movement device and which is connected to an air branch line. The liquid pump is moved by a recoil effect of the moving liquid against the bottom of the tank.

DE 101 27 228 B4 describes an apparatus for fermenting organic substances. A stirring device which is arranged movably about a vertically oriented longitudinal axis is driven in a rotatable manner by means of a force transmission means designed as a cable or belt.

### SUMMARY OF THE INVENTION

The present invention is based on the object of providing an apparatus which can be installed even in existing treatment tanks without a large outlay and which is also distinguished by high functional reliability and by simple cleaning and maintenance possibilities. Furthermore, a plant equipped in such a manner for the treatment of wastewater and sludge is to be provided with a treatment tank.

The present invention provides an apparatus having a feed line of flexible and/or elastic design, and a wastewater distributor that is movable in a reversing manner between opposite edge regions of the treatment tank by means of a traction mechanism. Owing to the fact that, according to the invention, the wastewater distributor is moved to and fro continuously or intermittently in the treatment tank, a uniform introduction of wastewater into the treatment tank can be realized with a low outlay on production and, in particular, with, for example, a single wastewater distributor. In this case, the wastewater distributor basically does not require any guidance or support on a fixedly installed device of the treatment tank. On the contrary, the wastewater distributor is connected to the surroundings merely by means of the traction mechanism and the feed line. Furthermore, for this reason, the feed line can easily be removed as a unit from the treatment tank for maintenance or for repair purposes, and therefore emptying of the treatment tank is not required. The operation of the apparatus is thereby substantially simplified. In addition, the apparatus also permits simple modular expandability. In this case, valves can be dispensed with in the wastewater distributor, and at the same time a low flow speed and minimization of energy can be realized. The device is equally suitable for aerobically, anaerobically and anoxically operated plants.

A particularly advantageous embodiment of the present invention is achieved in that the wastewater distributor has a main extent substantially transversely with respect to the direction of movement and in this case is designed in particular as an elongated pipe, with it being possible for the free pipe cross section of the wastewater distributor in the direction of the extent thereof to be varied depending on the intended use and the connection of the feed line.

The traction mechanism could be connected in each case to opposite tank edges by a respective winding drum, in particular a drive, such that the traction force is introduced either by the one or the other drive. By contrast, it is particularly simple if the traction mechanism is of endlessly circulating design and if, on opposite tank edges, just a deflection pulley is required on one side and a driving wheel on the other side in order to transmit the driving power to the traction mechanism. The traction mechanism can then be moved both in a circulating manner and in a reversing manner.

In principle, in particular in the case of comparatively small treatment tanks, manual actuation of the traction mechanism is easily possible. By contrast, it is particularly advantageous if the traction mechanism has a drive, in particular an electric motor drive, in order thereby to ensure continuous operation.

In this case, it is particularly suitable in practice if, depending on the preferred manual or motorized actuation of the traction mechanism, the latter has a cable pull, a belt, a belt band or a chain, with simple detection of the respective position of the wastewater distributor at a particular instant being possible in particular by means of a toothed belt or a chain on account of the chain links or teeth which can be identified for this purpose.

A modification promising particular success is also achieved in that the feed line is guided on a chain arranged in the treatment tank. Defined guidance of the feed line during the movement of the wastewater distributor by means of the traction mechanism between opposite edge regions of the treatment tank is thereby achieved in a simple manner, and therefore, in particular, an uncontrolled shifting of the feed line, which, under some circumstances, obstructs the predetermined movement, is avoided. For example, a plastic power chain is suitable for such a defined movement, in particular winding movement, said power chain holding the feed line in order thereby to restrict the movement of the feed line to a single plane. Furthermore, a configuration is also conceivable, in which the traction mechanism which is driven in a reversing manner for this purpose at the same time holds the feed line.

In another advantageous configuration, the feed line is guided on a multi-joint arm, with a parallelogram guide and also a length-variable hose which is deformable in accordance with the concertina principle being suitable in practice and, for this purpose, according to a further variant, the feed line is designed at least in some sections as a corrugated hose.

Another modification likewise promising particular success is achieved in that the feed line is free from lateral guides and therefore does not cause any additional structural outlay. In addition, the feed line can be equipped with buoyancy or with additional buoyant elements such that it does not sink onto the bottom of the treatment tank.

A development of the present invention has also proven particularly practical, in which the wastewater distributor has adjustable buoyancy in order thereby to be able to easily adjust the distance in relation to the bottom of the treatment tank.

For this purpose, according to a further expedient embodiment, the wastewater distributor can have a ballast receptacle, with it being possible for the ballast to slide on the bottom of the treatment tank in order to establish a defined distance and for it to be connected to the wastewater distributor by a connecting element of predetermined or adjustable length.

Another modification likewise promising success is achieved in that of the outlet openings at least individual ones are inclined in relation to the horizontal, in particular are directed downward, such that wastewater emerging through the outlet openings leads to additional buoyancy or else downforce of the wastewater distributor and therefore a contact free sliding of the wastewater distributor in the treatment tank is ensured.

Another particularly advantageous development of the apparatus according to the invention is achieved in that the wastewater distributor has at least one sensor for detecting essential parameters of the wastewater to be treated, in order thereby to permit monitoring of the wastewater present in the treatment tank in a simple manner In this case, the measured values can also be detected, for example, in a spatially resolved manner as a function of the particular position of the wastewater distributor in the treatment tank.

Another modification which is likewise particularly suitable in practice is achieved if the wastewater distributor has an outer contour promoting thorough mixing of the wastewater fed in and of the wastewater already present in the treatment tank. By this means, the wastewater distributor, by its movement in the treatment tank, simultaneously carries out the function of introducing the wastewater and also the thorough mixing thereof. For this purpose, flow directing elements can be correspondingly positionable on the wastewater distributor.

It has furthermore proven advantageous if the feed line is arranged on the tank bottom in the direction of movement of the wastewater distributor and can thereby run below a gas collector or a three-phase separation without the risk of a collision.

In principle, the feed line can be connected centrally or laterally as desired to the wastewater distributor. By contrast, it is particularly simple if the feed line is guided transversely with respect to the direction of movement of the wastewater distributor with respect to a side edge, and for this purpose, a conveying unit which is submerged into a wastewater feed is movable together with the wastewater distributor by means of the traction mechanism. This enables treatment tanks of virtually any size, in particular flat treatment tanks, to be supplied without the feed line having to be changed for this purpose. On the contrary, the wastewater passes through a stationary, open wastewater feed into the feed line which, for this purpose, is moved to and fro in the wastewater feed.

The wastewater distributor could be designed as a pipe length, the end sections of which are closed such that the wastewater can emerge exclusively through the outlet openings on the circumference of the pipe length. By contrast, it has proven particularly expedient if the wastewater distributor is of annularly closed design such that pressure is equalized in the wastewater distributor in a simple manner irrespective of the location at which the wastewater is introduced, and at the same time the mechanical stability is improved. In addition, the wastewater distributor can also have a plurality of outlet openings in different planes, with reference to the liquid level.

The second-mentioned object of providing a plant equipped with an apparatus for the treatment of wastewater and sludge, with a gas collector which is arranged in a treatment tank and is intended for trapping gases produced or introduced, is achieved according to the invention in that the feed line is of deformable design, and the wastewater distributor is movable in a reversing manner between opposite edge regions of the treatment tank by means of a traction mechanism. This for the first time realizes a plant without a fixed guide for the wastewater distributor, with the distance in relation to the bottom of the treatment tank being adjustable by adjusting the buoyancy. As a result, the wastewater distributor can be removed at any time from the wastewater without having to empty the treatment tank.

The invention permits numerous embodiments. To further clarify its basic principle, one of said embodiments is illustrated in the drawing and is described below. In the drawing, in each case in a schematic illustration,

### BRIEF DESCRIPTION OF THE DRAWINGS

FIG. 1 shows a side view of an apparatus according to the invention for the treatment of wastewater in a treatment tank;

FIG. 2 shows a top view of a further embodiment of an apparatus with a lateral wastewater feed.

### DETAILED DESCRIPTION

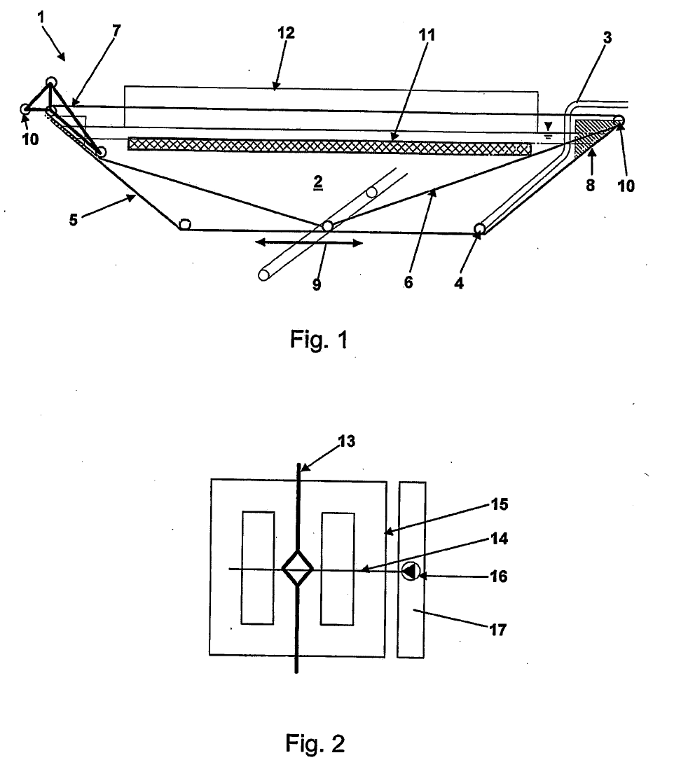

FIG. 1 shows an apparatus 1 for the treatment of wastewater 2 in a side view. The apparatus 1 is equipped with a feed line 3 for the wastewater 2, which feed line is connected to a wastewater distributor 4. In order to introduce the wastewater uniformly into a treatment tank 5, the wastewater distributor 4 is arranged movably in a reversing manner between opposite edge regions 7, 8 of the treatment tank 5 in the direction of the double arrow 9 by means of an endlessly circulating traction mechanism 6. For this purpose, the tubular feed line 3 is of elastically deformable design. In this case, the movement takes place by means of deflection pulleys 10, which are arranged on the edge regions 7, 8, in such a manner that impairment of the three-phase separation 11, which is arranged above the wastewater distributor 4, and of a gas collector 12 is prevented.

FIG. 2 illustrates a different embodiment of an apparatus 13 according to the invention in a top view, in which a feed line 14 is guided transversely with respect to the direction of movement of the wastewater distributor 4 with respect to a side edge 15 of the treatment tank 5. The feed line 14 is assigned a conveying unit 16 for feeding the wastewater which is to be treated from a wastewater feed 17, which is designed in the form of a passage, into the feed line 14, with the conveying unit 16 being movable synchronously with respect to the wastewater distributor 4 which is movable by means of a traction mechanism.

1-21. (canceled)

22. An apparatus for treating wastewater comprising:
a treatment tank having a first edge region and a second edge region opposite the first edge region;
a feed line configured to provide the wastewater to the treatment tank;
a movable wastewater distributor connected to an end of the feed line and configured to distribute the wastewater in the treatment tank, wherein the wastewater distributor includes a plurality of outlet openings and is moveable within the treatment tank; and
a traction mechanism configured to move the wastewater distributor in a reversing manner between the first and second opposite edge regions of the treatment tank, wherein the feed line is elastically deformable so as to allow a movement of the wastewater distributor in a direction of back and forth movement.

23. The apparatus as recited in claim 22, wherein the wastewater distributor has a main extent substantially transverse to the direction of back and forth movement.

24. The apparatus as recited in claim 22, wherein the wastewater distributor includes an elongated pipe.

25. The apparatus as recited in claim 22, wherein the traction mechanism is operable in an endlessly circulating manner.

26. The apparatus as recited in claim 22, wherein the traction mechanism includes an electric motor drive.

27. The apparatus as recited in claim 22, wherein the traction mechanism includes a cable pull, a belt, a belt band and/or a chain.

28. The apparatus as recited in claim 22, further comprising a link chain disposed at the treatment tank configured to guide the feed line.

29. The apparatus as recited in claim 22, further comprising a multi-joint arm disposed at the treatment tank configured to guide the feed line.

30. The apparatus as recited in claim 22, wherein the feed line includes a corrugated hose.

31. The apparatus as recited in claim 22, wherein the feed line is free from lateral guides.

32. The apparatus as recited in claim 22, wherein the wastewater distributor has adjustable buoyancy.

33. The apparatus as recited in claim 22, wherein the wastewater distributor has a downforce receptacle.

34. The apparatus as recited in claim 22, wherein at least one of the plurality of outlet openings is inclined relative to the horizontal.

35. The apparatus as recited in claim 22, wherein the wastewater distributor includes at least one sensor configured to detect at least one parameter of the wastewater.

36. The apparatus as recited in claim 22, wherein the wastewater distributor has an outer contour promoting a mixing of the wastewater being fed into the treatment tank with a wastewater already present in the treatment tank.

37. The apparatus as recited in claim 22, wherein he feed line is disposed on a bottom of the treatment tank parallel to the direction of back and forth movement of the wastewater distributor.

38. The apparatus as recited in claim 22, wherein the feed line is guided transversely to a side edge of the treatment tank relative to the direction of back and forth movement.

39. The apparatus as recited in claim 38, further comprising a wastewater feed and a conveying unit operatively connected to the feed line, the feed line feeding the wastewater from the wastewater feed.

40. The apparatus as recited in claim 39, wherein the conveying unit is movable synchronously with the wastewater distributor.

41. The apparatus as recited in claim 22, wherein the wastewater distributor is annularly closed.

42. A wastewater treatment plant for treating wastewater and sludge, comprising:
a treatment tank having a first edge region and a second edge region opposite the first edge region;
a feed line configured to provide the wastewater;
a movable wastewater distributor connected to an end of the feed line and configured to distribute the wastewater in the treatment tank, wherein the wastewater distributor includes a plurality of outlet openings and is moveable within the treatment tank;
a traction mechanism configured to move the wastewater distributor in a reversing manner between the first and second opposite edge regions of the treatment tank, wherein the feed line is elastically deformable so as to allow a movement of the wastewater distributor in a direction of back and forth movement; and
a gas collector disposed above the a treatment tank and configured to trap gases emanating from the treatment tank.
